(19) United States
(12) Patent Application Publication
(10) Pub. No.: US 2008/0053766 A1
(43) Pub. Date: Mar. 6, 2008

(54) Motorcycle lock

(76) Inventor: Vincenzo F. Costa, Huntington Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/514,565

(22) Filed: Sep. 1, 2006

(51) Int. Cl. B60T 11/00

(52) U.S. Cl. 188/344

(57) ABSTRACT

An integrated disk caliper brake and disk lock for a bicycle or a motorcycle is provided. The caliper brake of the present invention is adapted to work for a wheel rotationally fixed to a motorcycle frame. The caliper has an elongated main body, which extends generally in parallel with suspension members connected through a rocker arm to a wheel axle. The caliper body has a first chamber half, which accommodates a piston-activated brake pad. The chamber communicates with a fluid reservoir through the flexible brake line. A series of catch holes are disposed at an even distance along a circle about the center of the wheel axle. At an area of main body of caliper opposing disk, a latch engages one of the holes. A latch has a locking mechanism, which is integral to caliper brake main body.

### BACKGROUND OF THE INVENTION

A. Field of the Invention

The present invention relates to a monolithic caliper brake lock. More particularly, the present invention relates to a lockable caliper brake for locking a motorcycle.

B. Description of the Prior Art

Locks for motorcycles provide security against an increasing number of motorcycle thefts. Disc-locks are known for their simplicity to protect vulnerable two wheeled vehicles that are structurally open to lock picking.

As described in U.S. Pat. No. 5,492,206, a disk lock can prevent the wheel from turning and is convenient and portable compared to a cable or large U-lock, which are unfortunately too bulky and heavy to carry. Known disk locks are portable devices engaging a disk, which co-rotates with the wheel. The disk cooperates with the brake caliper for imparting a frictional force to stop the wheel.

To endure sawing or severing attacks, locks are made of various heavy metals and sometimes require an extra routine to lock and unlock. The user also needs to find a convenient place to stow the lock while riding. Other bothersome and harmful results of using conventional disk locks are associated with forgetting to inactivate such locks at the moment of starting the vehicle.

Considering the drawbacks associated with prior art devices, an object of the present invention is to provide a caliper brake with an integrated lock. Another object of the present invention is to provide a lockable caliper brake that does not add significantly to the cost, weight or complexity of manufacture.

Yet another object of the present invention is to provide a lockable caliper brake that easily adapts to incorporate current advancement of lock design and each lockable caliper brake may have different lock puzzles as well as levels of security.

### BRIEF DESCRIPTION OF THE DRAWINGS

FIG. 1 is a side elevational view of a lockable caliper brake of the present invention, shown mounted on a motorcycle suspension and engaging an axle mounted on the wheel hub.

FIG. 2 is an enlarged perspective view of the caliper brake of FIG. 1.

FIG. 3 is a front view of the caliper brake of FIG. 1.

FIG. 4 is a perspective view of the caliper brake illustrating the operation thereof.

### DETAILED DESCRIPTION OF THE PREFERRED EMBODIMENT

The present invention is an integrated disk caliper brake and disk lock for a motorcycle. The illustrative caliper brake is a hydraulic system involving an internal fluid passage but it may be a mechanical caliper brake that has a pull cable and an integral lock engaging one of a at least one holes of the disk brake. As is well known in the cycle technology and illustrated in Vince Costa's U.S. patent application Ser. No. 11/225475 entitled Fluid Passage Layout For Integrated Motorcycle Brake And Suspension System the disclosure of which is incorporated herein by reference and Pelfrey's U.S. Pat. No. 5,259,483, the disclosure of which is incorporated herein by reference, and disk brake calipers for motorcycles have opposing brake pads to grip a rotating member about the wheel axle in response to an activation of handle lever. The rotating member may be a one or more sprocket in a motorcycle that interacts with the caliper to stop the rotation of a wheel and thus the motorcycle.

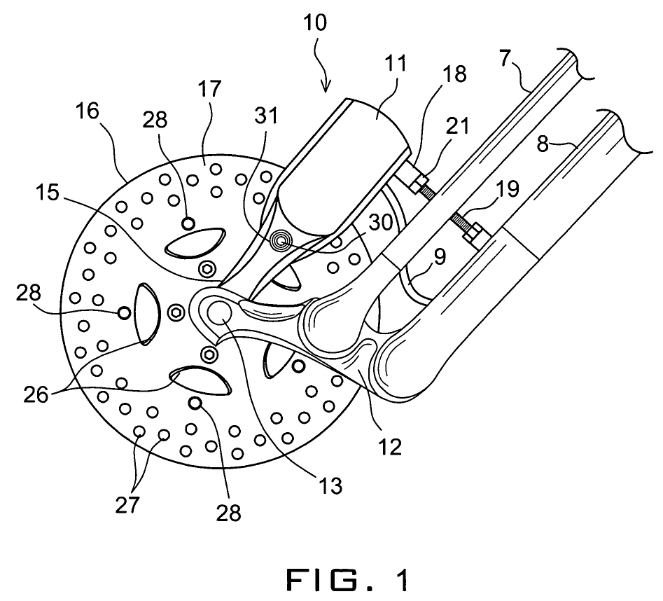

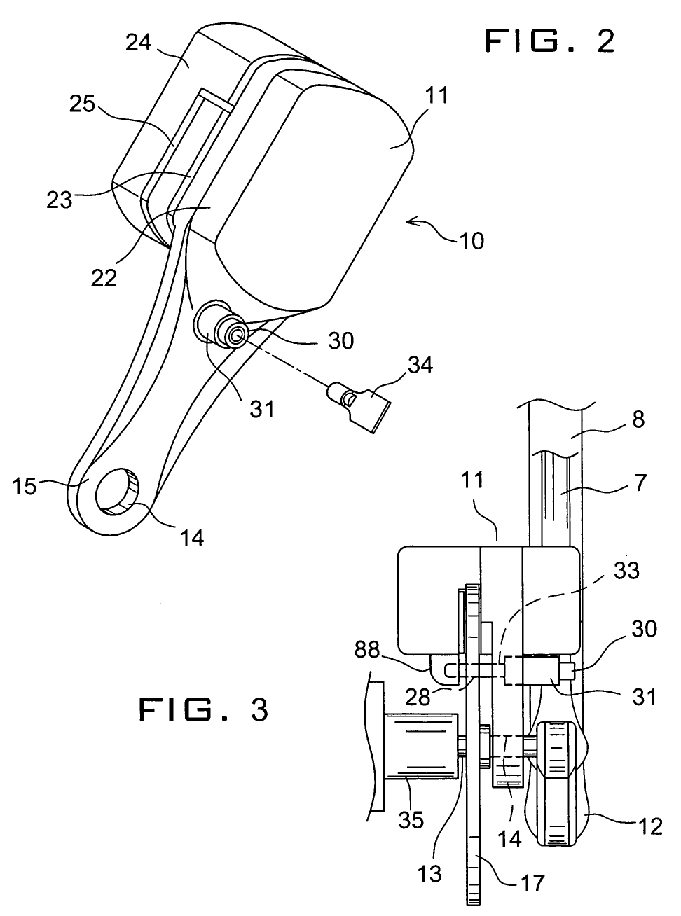

Referring to FIGS. 1 and 2, two members form a pair of suspension members 7, 8 forming a springer suspension configuration fork. Although the lock is shown attached to the springer configuration, the lock can also be attached to a traditional suspension configuration. The suspension members 7, 8 are similar in operation, and physical components, but the suspension member 8 has an internal brake line 9 and a lockable caliper brake 10.

Caliper brake 10 of the present invention is adapted to work for a wheel rotationally fixed to a motorcycle frame not shown. Caliper brake 10 has an elongated main body 11 of metal, which extends generally in parallel with suspension members 7, 8 connected through a joint member or rocker arm 12 to a wheel axle 13. Main body 11 has a lower bore 14 for receiving wheel axle 13. Caliper body 11 extends upwards from its proximal end 15 about axle 13 and beyond a peripheral edge 16 of a disk 17, which is also connected rotationally about axle 13. Upper portion of caliper body 11 is connected to suspension member 8 via an adjustable link 18, which has a threaded rod 19 and two end tubes 20 with nuts 21 for receiving the rod 19 adjustably.

Caliper body 11 has a first chamber half 22, which accommodates a piston-activated brake pad 23. Chamber 22 communicates with a fluid reservoir (not shown) through the flexible brake line 9. The locking latch can be mounted to the first chamber half.

Brake pad 23 may be advanced or retracted by a hydraulic force transmitted through brake line 9. At the opposite side of the disk 17 is a second chamber half 24 for holding another piston-activated brake pad 25. Chambers 22, 25 are joined together straddling a top area of disk 17 allowing an uninterrupted rotation of the disk 17 and the associated wheel.

Upon activation of a handle lever by the driver of the motorcycle two brake pads 23, 25 move toward disk 17 to pinch it between them stopping any rotational movement of the wheel axle 13 and the wheel.

Alternatively, for bicycles where power to break may be substantially lower, a pull cable may replace brake line 9 in operating brake pads 23, 25.

In order to facilitate faster cooling of disk 17, which may abruptly reach at a very high temperature during repetitive breakings, disk 17 may have several large holes 26 near its rotational axis and multiple smaller perforations 27 distributed peripherally in the disk 17 where cooling air can pass. These cooling holes 26, 27 are transversely oriented, usually perpendicular to the disk rotor 17 surface. Cooling holes may not all be catch holes, but catch holes can function as cooling holes.

According to the present invention, a series of catch holes 28 are disposed at an even distance along a circle about the center of the wheel axle 13. At an area of main body 11 of caliper 10 opposing disk 17, a latch 30 is positioned to engage one of the holes 28. Latch 30 has a locking mechanism 31, which is integral to main body 11 of caliper brake 10. Latch 30 itself may be chosen from different generic tubular key lock cylinders depending upon the security level appropriate versus cost affordable and it may be readily integrated into main body 11 of caliper 10 by welding.

Referring further to FIG. 3, latch 30 is received deep into a recess 32 formed on the middle surface of main body 11 facing away from disk 17. Recess 32 is also provided with a through-hole 33, which is distanced from lower bore 14 the same length as the radius of the annular arrangement of the catch holes 28. Latch 30 normally rests in recess 32 until a cylinder key 34 turns latch 30 into a locking position to immediately penetrate one of the holes 28 in the circular arrangement thereby immobilizing the wheel/disk assembly against the cycle frame. A wheel hub 35 is partially shown engaging axle 13. Turning key 34 to its open position will retract latch 30 out of engagement with disk 17.

The latch formed as a latch body with a protruding latch member can pass through the disk via a catch hole 28 and engage a receiver 88. It the receiver is opposite the latch body 31, the receiver will provide additional security for the latch member 33. The receiver should be formed as a metal member having a hollow bore securely receiving the latch member. The receiver 88 preferably is attached to the caliper member 11, 24 and can be integrally formed with the caliper member. The receiver 88 is preferably mounted as close to the rotor as possible.

The lockable caliper of the present invention is constantly adaptable to evolving tactics of trying to defeat existing lock structures by integrating newer designs of latch 30 into caliper body 11 in the same way as described above. Such a renewed caliper 10 may easily replace old versions to keep the vehicle secure as the street environment changes.

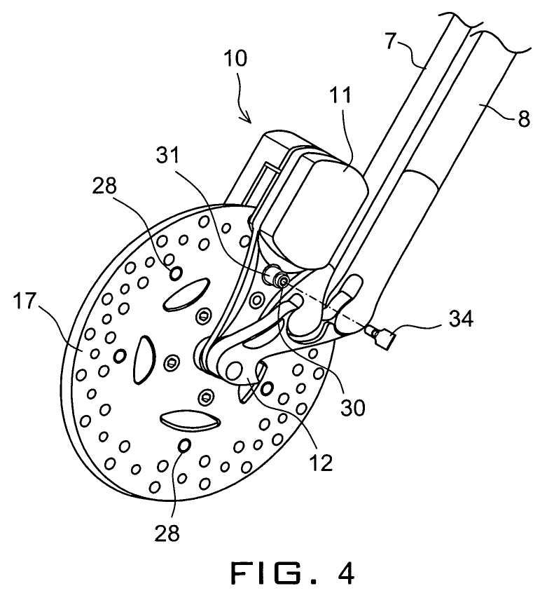

With reference to FIG. 4, operation of the cycle caliper brake 10 will be described. Because locking mechanism 31 and caliper 10 are in unity the motorist only needs to carry the tiny key 34 before and after locking the cycle. At a parking location, the driver may remain seated while inserting key 34 in latch 30. Turning key 34 to advance latch 30 toward disk 17, the driver rolls the wheel slightly back and forth to find an alignment with one of the catch holes 28. When the latch 30 snugly penetrates the catch hole 28, the disk 17 as well as the wheel becomes immovable. Since the tolerance of the catch holes 28 can be accurately controlled when boring the same, any wheel movements after activating the latch 30 are minimized. Therefore, with the wheel locked according to the present invention a forced traction of the cycle will not incur a jolt or impediments of the wheel components about the axle.

While safeguarding the cycle, the latch 30 is advantageously surrounded by steel masses of caliper body 11, rocker arm 12 and suspension members 7, 8 blocking the access of a cutting tool. This fortifies the latching mechanism to discourage theft.

If the rider tries to start the motorcycle neglecting a front locked wheel, the front tire will react to the adverse force preventing rotation. A conventional lock may damage the motorcycle by powered wheel. Here, a brief skidding of the locked tire will immediately remind the driver of the existence of the latch 30 saving the latching system from damage as well as maintaining the driver's own safety. The user can unlock the motorcycle front wheel and ride the motorcycle.

Therefore, while the presently preferred form of the monolithic caliper brake and lock for cycles has been shown and described, and several modifications thereof discussed, persons skilled in this art will readily appreciate that various additional changes and modifications may be made without departing from the spirit of the invention, as defined and differentiated by the following claims.

It is to be understood that the present invention is not limited to the sole embodiment describe above, but encompasses any and all embodiments within the scope of the following claims.

1. A motorcycle lock for a motorcycle comprising:
a disk rotor on an axle;
at least one catch hole formed transversely on the rotor;
a locking latch transversely mounted to engage one of the at least one catch hole.

2. The motorcycle lock of claim 1, wherein the locking latch is mounted to the motorcycle.

3. The motorcycle lock of claim 1, further comprising: a caliper body holding a caliper brake to impart a braking force to the disk rotor; wherein the locking latch is mounted to the caliper body.

4. The motorcycle lock of claim 3, wherein the locking latch is a tubular key lock cylinder.

5. The motorcycle lock of claim 4, wherein the locking latch is mounted on a caliper body having a lower bore for receiving a wheel axle.

6. The motorcycle lock of claim 5, wherein the caliper body further comprises a first chamber half that accommodates a piston-activated brake pad, wherein the locking latch is mounted to the first chamber half.

7. The motorcycle lock of claim 6, wherein an upper portion of the caliper body is connected to a suspension member via an adjustable link.

8. A motorcycle lock comprising:
a disk rotor on an axle;
at least one cooling hole formed transversely on the rotor;
a locking latch transversely mounted to engage one of the cooling holes;
a caliper body holding a caliper brake to impart a braking force to the disk rotor; wherein the locking latch is affixed to the caliper body.

9. The motorcycle lock of claim 8, wherein the locking latch is a tubular key lock cylinder.

10. The motorcycle lock of claim 8, wherein the locking latch is mounted on a caliper body having a lower bore for receiving a wheel axle.

11. The motorcycle lock of claim 10, wherein the caliper body further comprises a first chamber half that accommodates a piston-activated brake pad, wherein the locking latch is mounted to the first chamber half.

12. The motorcycle lock of claim 11, wherein an upper portion of the caliper body is connected to a suspension member via an adjustable link.

13. A motorcycle lock comprising:
a disk rotor rotably mounted on an axle;
at least one catch hole formed transversely on the disk rotor;
a locking latch transversely mounted to engage the at least one catch hole;
a latch receiver mounted on the opposite side of the locking latch and positioned to receive a latch member of the locking latch.

14. The motorcycle lock of claim 13, wherein the locking latch is mounted to the motorcycle.

15. The motorcycle lock of claim 13, wherein the caliper body holds a caliper brake to impart a braking force to the disk rotor; wherein the locking latch is affixed to the caliper body, wherein the locking latch is a cylinder lock.

16. The motorcycle lock of claim 13, wherein the caliper body further comprises a first chamber half that accommodates a piston-activated brake pad, wherein the locking latch is mounted to the first chamber half.

17. The motorcycle lock of claim 16, wherein an upper portion of the caliper body is connected to a suspension member via an adjustable link.

18. The motorcycle lock of claim 13, wherein the locking latch is mounted on a caliper body having a lower bore for receiving a wheel axle.

19. The motorcycle lock of claim 18, wherein the caliper body further comprises a first chamber half that accommodates a piston-activated brake pad, wherein the locking latch is mounted to the first chamber half.

20. The motorcycle lock of claim 19, wherein an upper portion of the caliper body is connected to a suspension member via an adjustable link.
